(19) United States
(12) Patent Application Publication
(10) Pub. No.: US 2025/0320844 A1
(43) Pub. Date: Oct. 16, 2025

(54) Stirling Machine Generation

(71) Applicant: Arne HØEG, Hvalstad (NO)

(72) Inventor: Arne Hoeg, Hvalstad (NO)

(21) Appl. No.: 18/872,932

(22) PCT Filed: Jun. 6, 2023
(86) PCT No.: PCT/NO2023/050128

§ 371 Date: Dec. 9, 2024

(30) Foreign Application Priority Data
Jun. 9, 2022 (NO) 20220661

(51) Int. Cl. F02G 1/044; F02G 1/043; F02G 1/053; F25B 9/14

(52) U.S. Cl. CPC F02G 1/044; F02G 1/043; F02G 1/053; F25B 9/14

(57) ABSTRACT

The invention is a stirling machine configuration that can be realized with the smallest possible gas dead volumes relative to the pumping losses between the active components (i.e. cylinders, heat exchangers, pistons and displacers. A further object of the invention is to make possible a stirling machine configuration where it is possible to design the machine so that the piston rings can operate at a temperature high enough to avoid brittleness, and low enough to avoid accelerated wear. Even if the temperatures in one or more of the cylinder volumes are outside the temperature region of 0 to 150° C., it will be possible to design the pistons so that the piston rings experience temperatures within this range, as there will be a temperature gradient in both the cylinders and the pistons.

### CROSS-REFERENCES TO RELATED APPLICATIONS

This Non-Provisional Patent Application claims the benefit of and priority to PCT Application Serial No. PCT/NO2023/050128, filed Jun. 6, 2023, entitled “Stirling Machine Configuration,” which claims the benefit of and priority to Norway patent application Ser. No. 20/220,661, filed Jun. 9, 2022, entitled “Stirling Machine Configuration,” the entire contents of both applications of which are hereby incorporated herein by reference.

### FIELD OF INVENTION

The invention relates to a Stirling machine, that is a Stirling engine, a Stirling heat pump or a Stirling cooling machine.

### BACKGROUND

Stirling machines are heat engines with at least one closed gas circuit, consisting of an expansion volume, a compression volume, and at least three heat exchangers: an expansion heat exchanger, a regenerative heat exchanger and a compression heat exchanger. The expansion volume and the compression volume can be realized in different ways, usually as cylinder volumes in a piston machine. The cylinder volumes may be arranged in several ways, one of the common ways is called the gamma configuration, in which each circuit consists of a displacer cylinder, a power cylinder, and at least the three said heat exchangers. In addition, the components may be connected by gas conduits.

NO345179 shows a stirling machine, where the process circuits are organized in pairs, so that 3 pistons in 3 cylinders make up 2 similar process circuits, and a power piston separates the two processes in a power cylinder.

When the displacer piston is in its end positions, the gas flow through the conduit between the cylinders is at its highest flow rate. In a Stirling machine with a gas circuit swept volume of 1 liter, and cylinder diameter equal to piston stroke, operating at 1000 RPM, the gas flow through the conduit is up to 50 l/s. And when the displacer cylinder is in the lower position, the gas flow needs to flow through the cylinder, below the piston, to the heat exchanger. To avoid high pumping losses and pressure pulses, a considerable flow cross section must be allowed below the displacer, which adds to the dead volume of the circuit, and needs to be compensated by increasing the swept volume of the circuit and hence the power cylinder, to obtain the desired compression ratio. The extra volume in the displacer cylinder would need to be close to ⅓ of the swept volume.

In one of the circuits in the circuit pair, the volume below the displacer piston is connected to the volume above the power piston, and the gas conduit between the displacer cylinder and the power cylinder must be longer than the gas conduit of the other circuit, that connects two volumes that are below the pistons. For a Stirling machine of 1 liter and cylinder diameter equal to piston stroke, the conduit needs to be 1 dm longer than the conduit for the other circuit. The extra volume of the conduit is close to ⅙ of the swept volume.

If the gas conduits are arranged directly between the cylinders, with flow direction through the cylinder bank plane, the pressure on the flow area will result in a force on the cylinders. If the parts are bolted together, thermal expansion will lead to the cylinders being non-parallel, which may lead to side forces on the pistons, and if they are free to move, the gas forces may bend the cylinders from the ideal center lines and make them non-parallel. This can lead to side forces on the pistons, that may result in accelerated wear on the piston rings.

### SUMMARY

A main object of the invention is to disclose a configuration for Stirling-cycle machines, engines and heat pumps, that solves the problems that have been mentioned from the prior art disclosures.

The invention is a stirling machine configuration that can be realized with the smallest possible gas dead volumes relative to the pumping losses between the active components (i.e. cylinders, heat exchangers, pistons and displacers).

A further object of the invention is to make possible a Stirling machine configuration where it is possible to design the machine so that the piston rings can operate at a temperature high enough to avoid brittleness, and low enough to avoid accelerated wear. Even if the temperatures in one or more of the cylinder volumes are outside the temperature region of 0 to 150° C., it will be possible to design the pistons so that the piston rings experience temperatures within this range, as there will be a temperature gradient in both the cylinders and the pistons.

A still further object of the invention is to allow the design of a Stirling machine configuration with no un-balanced pressure forces on the cylinders.

A still further object of the invention is to allow the design of a Stirling machine configuration, where working medium does not need to be transferred through a cylinder volume between one cylinder volume and a heat exchanger.

The invention is a stirling machine configuration (0) comprising,
at least two process circuits (P1, P2),
at least three cylinders (D1, W12, D2),
at least three pistons (5, 6, 7) concentrically arranged in said three cylinders (D1, W12, D2),
at least two heat exchanger modules (1H, 2H),
characterized by;
at least one manifold (1me) is connected through conduits (1e, 1d) to at least two cylinder volumes (1a, 1c) and at least one heat exchanger module (1H).

### BRIEF DESCRIPTION OF THE DRAWINGS

The attached figures illustrate some embodiments of the claimed invention.

FIG. 1 depicts a typical Stirling circuit in the gamma configuration.

FIG. 2 depicts two Stirling circuits, according to the invention.

FIG. 3 depicts a 3-way connection between cylinder volumes and a heat exchanger according to the invention

FIG. 4 depicts a Stirling circuit in the gamma configuration, according to the invention.

FIG. 5 depicts parts of the process circuits of one embodiment of the invention.

### DETAILED DESCRIPTION

The invention will in the following be described and embodiments of the invention will be explained with reference to the accompanying drawings.

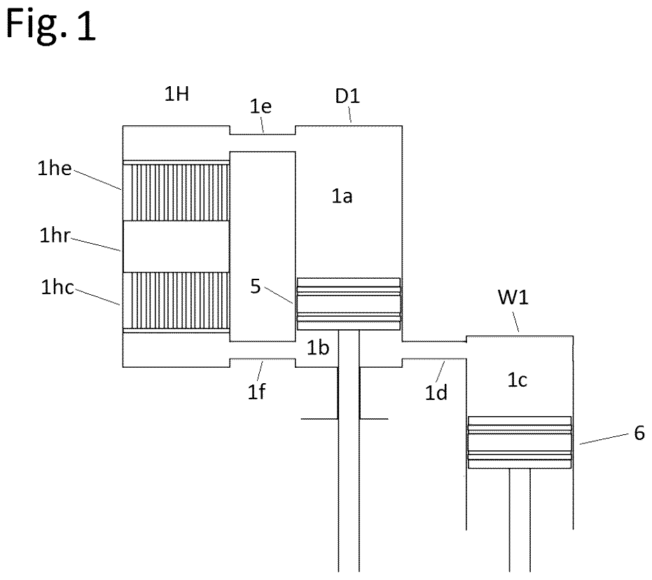

FIG. 1 shows the process components of a Stirling engine. The Stirling engine comprises of a power cylinder (W1) with a piston (6), a displacer cylinder (D1) with a displacer piston (5) and a heat exchanger arrangement (1H) consisting of an expansion heat exchanger (1he), a regenerator (1hr) and a compression heat exchanger (1hc), connected by gas conduits (1d, 1e, 1f). The displacer piston (5) separates the expansion volume (1a, 1e) from the compression volume (1b, 1c, 1d), and the piston (6) compresses and expands all the gas in the circuit. Other stirling engines may have different configurations, but common for all Stirling engines of significant power rating, is the existence of an expansion heat exchanger (1he), a regenerator (1hr) and a compression heat exchanger (1hc), connected in series, and separating two different cylinder volumes, either in a common cylinder like in FIG. 1, or in separate cylinders. Said heat exchanger arrangement (1H) is also referred to as heat exchanger module.

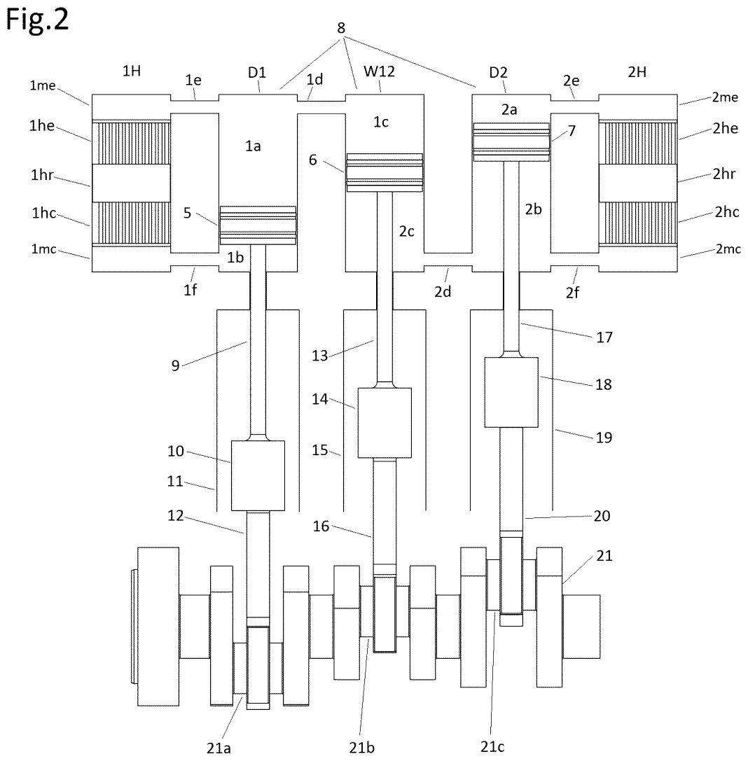

FIG. 2 shows a Stirling machine with two circuits (P1, P2) according to the invention.

Circuit (P1) comprises of the cylinder volumes (1a, 1b, 1c) and the heat exchanger module (1H) which consists of the heat exchangers (1he, 1hr, 1hc) and the two manifolds (1me, 1mc). The cylinder volumes (1a, 1b, 1c) and the two manifolds (1me, 1mc) are connected to each other by three gas conduits (1d, 1e, 1f). Said cylinder volumes (1a, 1c) are referred to as the expansion volume, and said cylinder volume (1b) is referred to as the compression volume of said circuit (P1). Circuit (P2) comprises of the cylinder volumes (2a, 2b, 2c) and the heat exchanger module (2H), which consists of the heat exchangers (2he, 2hr, 2hc) and the two manifolds (2me, 2mc). The cylinder volumes (2a, 2b, 2c) and the two manifolds (2me, 2mc are connected by three gas conduits (2d, 2e, 2f). Said cylinder volume (2a) is referred to as the expansion volume, and said cylinder volumes (2b, 2c) are referred to as the compression volume of said circuit (P2).

The cylinder volumes (1a, 1b) are separated by a piston (5) located concentrically in a cylinder (D1). The cylinder volumes (2a, 2b) are separated by a piston (7) located concentrically in a cylinder (D2). And the cylinder volumes (1c, 2c) are separated by a piston (6) located concentrically in a cylinder (W12). The closed circuits (P1, P2) are filled with a pressurized working medium, usually helium, hydrogen, nitrogen, or air.

Piston (5) is connected to a crankshaft (21) through a piston rod (9), a crosshead (10) guided by a crosshead liner (11), and a connecting rod (12). In a similar manner, piston (6) is connected to said crankshaft (21) through a piston rod (13), a crosshead (14) and a connecting rod (16), and piston (7) is connected to said crankshaft (21) through a piston rod (17), a crosshead (18) and a connecting rod (20). Said crankshaft (21) has 3 crank throws (21a, 21b, 21c), the angle between said crank throws (21a) and (21c) is normally 180°, and generally in the range 170° to 180°. The angle between said crank throws (21a) and (21b) is normally 90°, and generally in the range 80° to 100°.

When said crankshaft (21) is turned, the Process circuits (P1, P2) will operate according to the Stirling cycle. Said piston (6) will perform compression work and expansion work on both process circuits (P1, P2), said piston (5) will perform a displacement of the gas between the cylinder volumes (1a, 1b) through the heat exchangers (1H), and said piston (7) will perform a displacement of the gas between the cylinder volumes (2a, 2b) through the heat exchangers (2H).

If the Stirling machine in FIG. 2 is operated as a Stirling engine, more gas is compressed at a low temperature than at a high temperature, and more gas is expanded at a high temperature than at a low temperature. At the point during the process, that is shown in FIG. 2, piston (6) is moving downwards to expand the gas in process circuit (P1). Said piston (6) will also compress the gas in the process circuit (P2). In said process circuit (P1), gas is flowing from the cylinder volume (1a) through the conduit (1d) to the cylinder volume (1c). Since all the gas in the process circuit (P1) is expanding, gas is also flowing from cylinder volume (1b) through the heat exchangers (1H) to the cylinder volume (1a).

When the crankshaft has made a half turn from the point shown in FIG. 2, piston (6) is moving upwards to compress the gas in process circuit (P1). The piston (5) will be pass its top dead centre during the compression, and as the piston (6) compresses all the gas in process circuit (P1), most of the gas exiting cylinder volume (1c) will flow through conduit (1d), cylinder volume (1a), conduit 1e, and the heat exchangers (1H), to the cylinder volume (1b) via conduit (1f).

When the piston (6) has reached its top dead centre, the cylinder volume (1c) will be very small (i.e. at its smallest), while the piston (5) is moving downwards. Gas flows in the direction from cylinder volume (1b) through the heat exchangers (lhc, 1hr, 1he) via conduits (1f, 1e) to cylinder volume (1a).

During one revolution, gas will flow in all 6 possible directions between cylinder volume (1a), cylinder volume (1c) and heat exchanger (1he). Similarly, gas will flow in all 6 possible directions between cylinder volume (2b), cylinder volume (2c) and heat exchanger (2hc).

The minimum volume of each of the cylinder volumes (1a, 1b, 1c), the conduits (1d, 1e, 1f), and the manifolds (1me, 1mc), are collectively referred to as the dead volume of the circuit (1P). The dead volume consists of all parts of the circuit that are neither the swept volume of a piston, or a heat exchanger. Similarly, the dead volume of the circuit (P2) consists of the minimum volume of each of the cylinder volumes (2a, 2b, 2c), the conduits (2d, 2e, 2f), and the manifolds (2me, 2mc). In an embodiment of the invention, where conduit (1d) connects cylinder volume (1c) to cylinder volume (1a), and conduit (2d) connects cylinder volume (2c) to cylinder volume (2b), both conduits can be made as short as allowed by the distance between the cylinders. If the conduit (1d) were instead to connect cylinder volume (1c) to cylinder volume (1b), the length of the conduit would need to be increased by at least the stroke of piston (6) plus the length of piston (6). The dead volume of circuit (P1) in the Stirling machine configuration according to the invention, is thus lower than it would have been if it were to be designed according to NO 345179.

The three cylinders (D1, W12, D2) constitute a cylinder bank. In another embodiment of the invention, a second pair of process circuits (P1′, P2′) can be arranged similarly to the said pair of process circuits (P1, P2), and connected to the same crankshaft (21). The second pair of process circuits (P1′, P2′) will comprise three cylinders (D1′, W12′, D2′), and said cylinders (D1′, W12′, D2′) constitute a cylinder bank. The two cylinder banks may be arranged at an angle, for example 90°. If the angle between the crank throws (21a, 21c) is 180° and the angle between the cylinder banks is 90°, the Stirling machine will have 4 similar process circuits (P1, P1′, P2, P2′) spaced 90° apart. In other embodiments of the invention, multiple pairs of process circuits may be connected to the crankshaft. For example, 3 pairs or 4 pairs. If the crankshaft (21) is made with 6 crank throws (21a, 21b, 21c, 21a″, 21b″, 21c″), more pairs of process circuits may be connected to the same crankshaft, for example in a V12 configuration.

The Stirling machine according to the invention, may be used as a heat engine, a cryogenic engine, a heat pump, a cooling machine or a cryo cooler. The function will be determined by the temperatures in the heat exchangers (1he, 1hc, 2he, 2hc) and the direction of the rotation of the crankshaft (21). The designation of the cylinder volumes as expansion volumes and compression volumes, and similarly the use of the letters e and c in the figures, are used according to convention. When the Stirling machine according to the invention, is operated as a heat engine between a hot heat source and a cold heat sink, it would be common to install the Stirling machine so that the gas in the cylinder volumes (1a, 1c, 2a), the heat exchangers (1he, 2he) and the manifolds (1me, 2me) will be hotter than the gas in the cylinder volumes (1b, 2b, 2c), the heat exchangers (1hc, 2hc) and the manifolds (1mc, 2mc). Normally, more gas will be in the hot cylinder volumes (1a, 2a) than in the cold cylinder volumes (1b, 2b) during expansion, and less gas during compression. If the rotation of the crankshaft (21) is reversed, the Stirling machine becomes a heat pump.

In other use cases, the gas in the cylinder volumes (1a, 1c, 2a) may be colder than the gas in the cylinder volumes (1b, 2b, 2c). If more gas is in the cylinder volumes (1a, 2a) than in the cylinder volumes (1b, 2b) during compression, and less gas during expansion, the machine will operate as a cryogenic engine. If the rotation of the crankshaft is reversed, the machine will become a cooling machine or a cryogenic cooler.

In the Stirling machine according to the invention, all pistons (5, 6, 7) in a pair of process circuits (P1, P2) separate two gas volumes with different temperatures. If both circuits are operated on similar temperature conditions, that is if the temperatures of the heat exchangers (1he, 2he) are similar, and the temperatures of the heat exchangers (1hc, 2hc) are similar, the temperatures of the cylinder volumes (1a, 1c, 2a) will be similar, and the temperatures of the cylinder volumes (1b, 2a, 2c) will be similar. This allows the designer to design the pistons (5, 6, 7) with piston rings separating gas at two different temperature levels, and experience operating temperatures between the cylinder temperatures, and closer to either the hot cylinder temperature level or the cold cylinder temperature, if desired. For engine use, it may be beneficial to design the pistons with the piston rings arranged closest to the low temperature cylinder volume. For cryogenic coolers, it may be beneficial to design the pistons with the piston rings arranged closest to the high temperature cylinder volume.

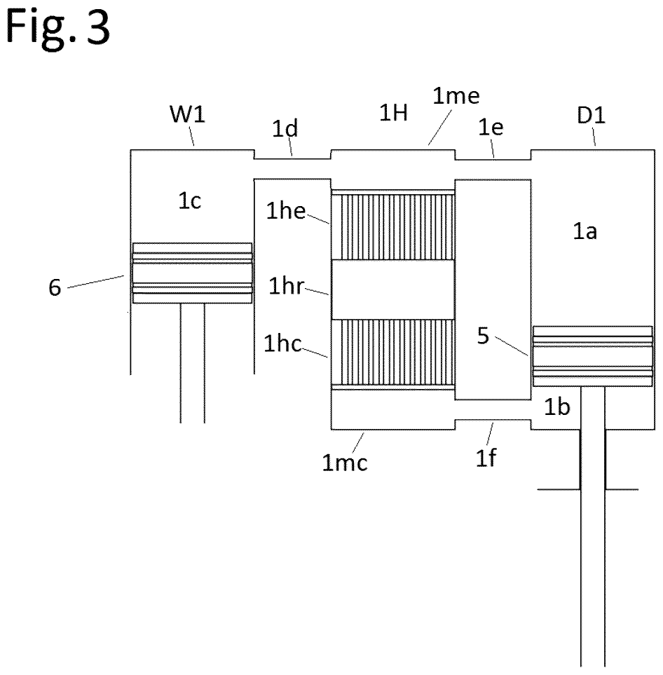

FIG. 3 shows a way to connect cylinder volume (1a), cylinder volume (1c) and heat exchanger (1he), to allow gas flow in all 6 directions, with the smallest possible dead volume for a given minimum flow cross section.

The manifold (1me) connects cylinder volume (1a) through conduit (1e), cylinder volume (1c) through conduit (1d) and the heat exchanger (1he). The principle is a Y (y) flow instead of a D (delta) flow, or a serial flow, which makes the shortest combined flow paths between three points.

In another embodiment of the invention, said conduit (1d) instead connects to the manifold (1mc) which then connects the cylinder volumes (1b, 1c) and the heat exchanger (1hc). In another embodiment of the invention, said cylinder volume (1c) is instead below the piston (6). This will be analogous to process circuit (P2) shown in FIG. 2.

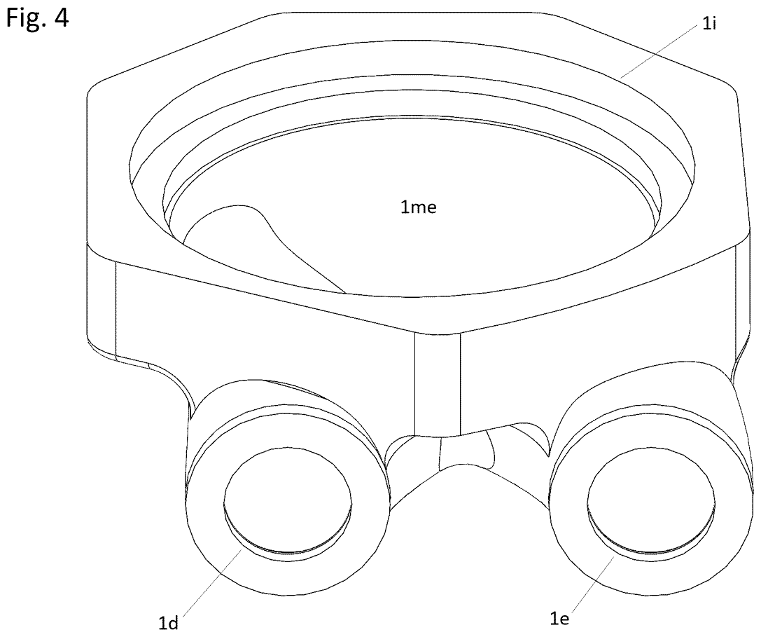

FIG. 4 shows one embodiment of a 3-way gas manifold (1me) according to the invention. The three interfaces with the 3-way gas manifold (1me) are with the heat exchanger (1he) through and via an opening (1i), the cylinder volume (1a) through and via a conduit (1e), and the cylinder volume (1c) through and via a conduit (1d).

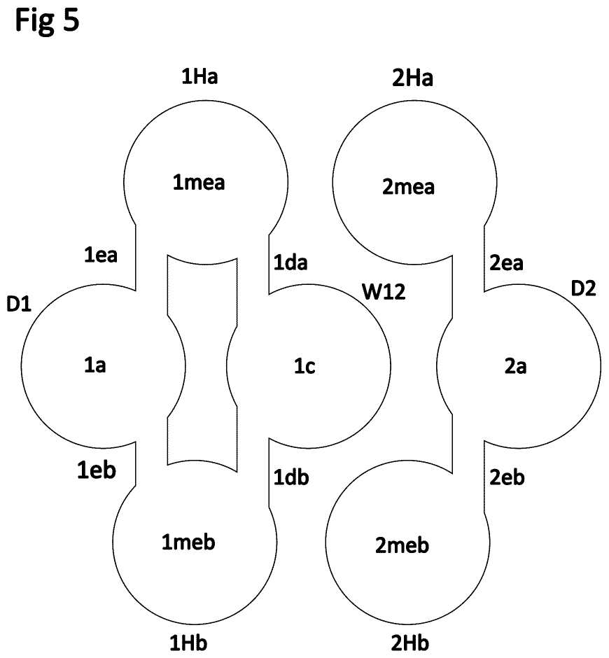

FIG. 5 is a principal cross section (plan view) through the cylinders (D1, W12, D2), of one embodiment of the invention, where each process circuit (P1, P2) has two heat exchanger modules (1Ha, 1Hb, 2Ha, 2Hb). The process circuits (P1, P2) are otherwise similar to the process circuits shown in FIG. 2.

The cross section is taken through the manifolds (1mea, 1meb, 2mea, 2meb), the cylinder volumes (1a, 1c, 2a) of the cylinders (D1, W12, D2), and the conduits (1ea, 1eb, 1da, 1db, 2ea, 2eb).

For a given circuit swept volume, and a given minimum conduit flow cross section per volume flow through the conduit, two heat exchanger modules per circuit, results in a lower combined dead volume per circuit, than one heat exchanger module per circuit, as the volume of a flow velocity scaled heat exchanger manifold scales with the cylinder diameter to the power of 3, while the swept volume scales with the cylinder diameter to the power of 2.

In one embodiment of the invention, the conduits (1ea, 1eb, 1da, 1db, 2ea, 2eb) are split between the manifolds (1mea, 1meb, 2mea, 2meb) and the cylinders (D1, W12, D2). Seals are used to seal between the parts. This solution will allow the heat exchanger modules (Hla, H1b, H2a, H2b) to move relative to the cylinders (D1, W12, D2). This may be the case if the components are deformed by pressure or temperature gradients. The gas pressure will act on the area within each conduit seal, and hence apply a force on both the manifold and the cylinder. The embodiment shown in FIG. 5 will allow the forces on each manifold to be balanced by the force on the opposing manifold, and to be transferred between the heat exchanger modules through support struts or similar. In this way, no mechanical force, or just a small force will be needed between the heat exchanger modules and the cylinders, and the relative movement of the components can be allowed with small mechanical forces on the cylinders, in directions normal to the cylinder axes. The consequence is that the cylinders will remain close to parallel in any operating conditions.

In the claims:

1. A stirling machine configuration comprising.
at least two process circuits,
at least three cylinders,
at least three pistons concentrically arranged in said three cylinders,
at least two heat exchanger modules,
wherein at least one manifold is connected through conduits to at least two cylinder volumes and at least one heat exchanger module.

2. A stirling machine configuration of claim 1, wherein:
at least one manifold is connected to two expansion volumes and said manifold is connected to at least one heat exchanger module, and
at least one manifold is connected through conduits to two compression volumes and said manifold is connected to at least one heat exchanger module.

3. A stirling machine configuration of claim 2, wherein:
a first process circuit comprises two heat exchanger modules, and
a second process circuit comprises two heat exchanger modules.

4. A stirling machine configuration of claim 3, where conduits or are split between said at least one manifold and sealed, to allow relative movement between the components.

5. A stirling machine of claim 4, wherein two pairs of process circuits are arranged in a V-configuration.

6. A stirling machine of claim 5, where said stirling machine can be used as a heat engine, a heat pump, a cooling machine or a cryogenic machine.
